(19) United States
(12) Patent Application Publication
(10) Pub. No.: US 2004/0102063 A1
(43) Pub. Date: May 27, 2004

(54) Electric connector

(76) Inventors: Hung-Jiun Yin, Wuxi City (CN); Yz-Jiun Wu, Wuxi City (CN)

Correspondence Address: MOLEX INCORPORATED, 2222 WELLINGTON COURT, LISLE, IL, 60532, US

(21) Appl. No.: 10/603,414

(22) Filed: Jun. 25, 2003

(30) Foreign Application Priority Data
Jun. 25, 2002 (TW) 91209578

(51) Int. Cl. H01R 12/00

(52) U.S. Cl. 439/66

(57) ABSTRACT

An electric connector formed of an electrically insulative housing and terminals installed in respective terminal slots of the housing is disclosed in which each terminal has a U-shaped springy supporting portion supported inside one terminal slot of the housing, a vertical arm downwardly extended from one end of the U-shaped springy supporting portion, and a contact tip extended from the bottom end of the vertical arm suspended outside the housing for the contact of a corresponding contact of a circuit board.

### FIELD OF THE INVENTION

The present invention relates to electric connectors and, more particularly, to such an electric connector, which effectively reduces the installation space of the matching circuit board and, achieves a satisfactory electric connection effect.

### DESCRIPTION OF THE RELATED ART

FIG. 1 shows an I/O (Input/Output) electric connector 1a for use in an electronic apparatus. This structure of electric connector 1a comprises an electrically insulative housing 10a, and a plurality of terminals 11a mounted in respective terminal slots 12a in the housing 10a. With reference to FIGS. 1 and 2, each terminal 11a comprises a cured springy supporting portion 13a, a contact tip 15a suspending outside the housing 10a, and a straight bearing arm 14a connected between the springy supporting portion 13a and the contact tip 15a. During installation, the contact tip 15a is maintained in contact with a respective contact 20a of the circuit board 2a inside the electronic apparatus.

The aforesaid prior art electric connector la has drawbacks. As shown in FIGS. 3 and 4, the straight bearing arm 14a is obliquely upwardly extended from the springy supporting portion 13a toward the contact tip 15a. When the circuit board 20a moved downwards and set into position after contact of the respective contacts 20a with the contact tips 15a of the terminals 11a of the electric connector 1a, the springy supporting portion 13a is deformed, and the sliding friction between the contact tips 15a of the terminals 11a and the contacts 20a of the circuit board 2a is shifted from position A to position B through a displacement distance S. Due to the sliding friction between the contact tips 15a of the terminals 11a and the contacts 20a of the circuit board 2a, the electronic apparatus must provide a room for such a displacement distance S. This design does not fit the current electronic apparatus design concept of minimizing the size. Further, the contact of sliding friction is not stable. Frequently detaching and re-installing the electric connector 1a and the circuit board 2a causes the contact tips 15a of the terminals 11a and the contacts 20a of the circuit board 2a to wear quickly.

Therefore, it is desirable to provide an electric connector that eliminates the aforesaid drawbacks.

### SUMMARY OF THE INVENTION

The present invention has been accomplished under the circumstances in view. It is therefore the main object of the present invention to provide an electric connector, which contacts the contacts of the matching circuit board through a point contact without producing a sliding friction so as to minimize the installation space of the matching circuit board and to meet the electronic apparatus design concept of minimizing the size.

To achieve this and other objects of the present invention, the electric connector comprises an electrically insulative housing, the housing comprising a plurality of terminal slots, and a plurality of terminals respectively mounted in the terminal slots of the housing and disposed in contact with respective contacts of a circuit board in an electronic apparatus, wherein the terminals each comprise a springy supporting portion supported inside one terminal slot of the housing, a vertical arm downwardly extended from one end of the springy supporting portion, and a contact tip extended from a bottom end of the vertical arm remote from the springy supporting portion and suspended outside the housing for the contact of one contact of the circuit board.

### BRIEF DESCRIPTION OF THE DRAWINGS

FIG. 1 is an exploded view of an electric connector and a circuit board according to the prior art.

FIG. 2 is a plain view in section of the electric connector and the circuit board according to the prior art.

FIG. 3 illustrates the initial contact stage between the circuit board and the electric connector according to the prior art.

FIG. 4 is similar to FIG. 3 but showing the circuit board set into position, the sliding friction between the contact tips of the terminals and the contacts of the circuit board shifted from position A to position B.

FIG. 5 is an exploded view of an electric connector according to the present invention.

FIG. 6 is an elevational view of in an enlarged scale of one terminal of the electric connector shown in FIG. 5.

FIG. 7 is a plain view in section of the electric connector and the matching circuit board according to the present invention.

FIG. 7A is an enlarged view of a part of FIG. 7.

FIG. 8 illustrates the initial contact stage between the contacts of the circuit board and the contact tips of the terminals of the electric connector according to the present invention.

FIG. 9 is similar to FIG. 8 but showing the U-shaped springy supporting portion of the terminal deformed.

FIG. 10 is a plain view in section of the electric connector and the matching circuit board according to an alternate form of the present invention.

FIG. 10A is an enlarged view of a part of FIG. 10.

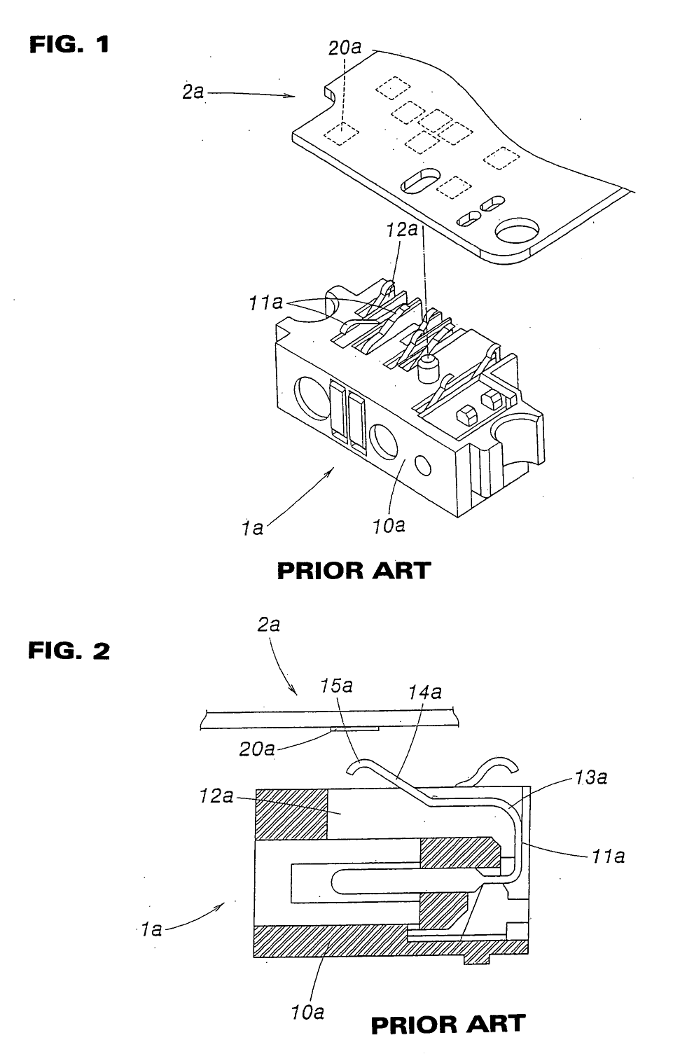

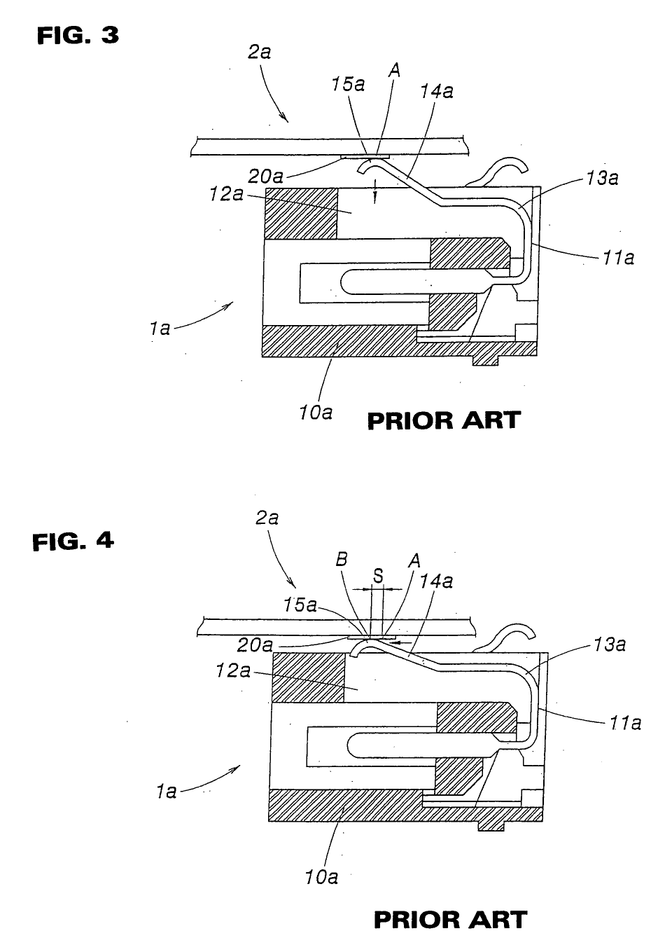

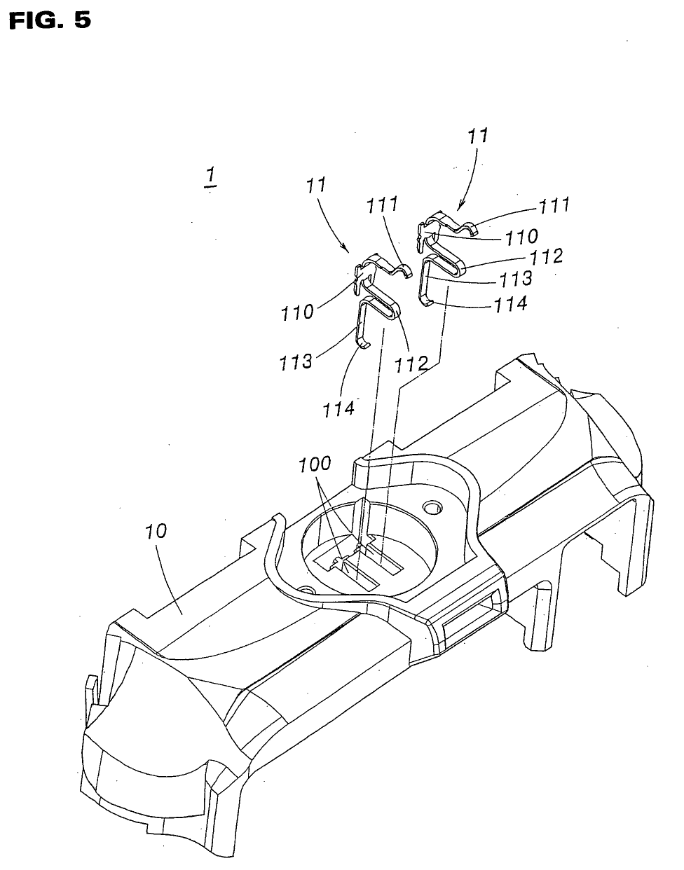

### DETAILED DESCRIPTION OF THE PREFERRED EMBODIMENT

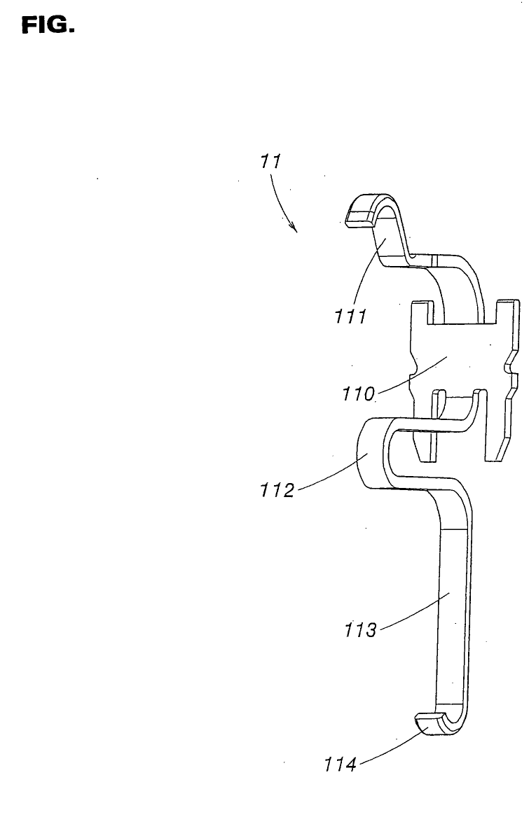

Referring to FIGS. 5˜7, an electric connector is installed in an electronic apparatus (not shown) and electrically connected to the contacts 20 of a circuit board 2 inside the electronic apparatus. The electric connector 1 comprises an electrically insulative housing 10 and a plurality of terminals 11.

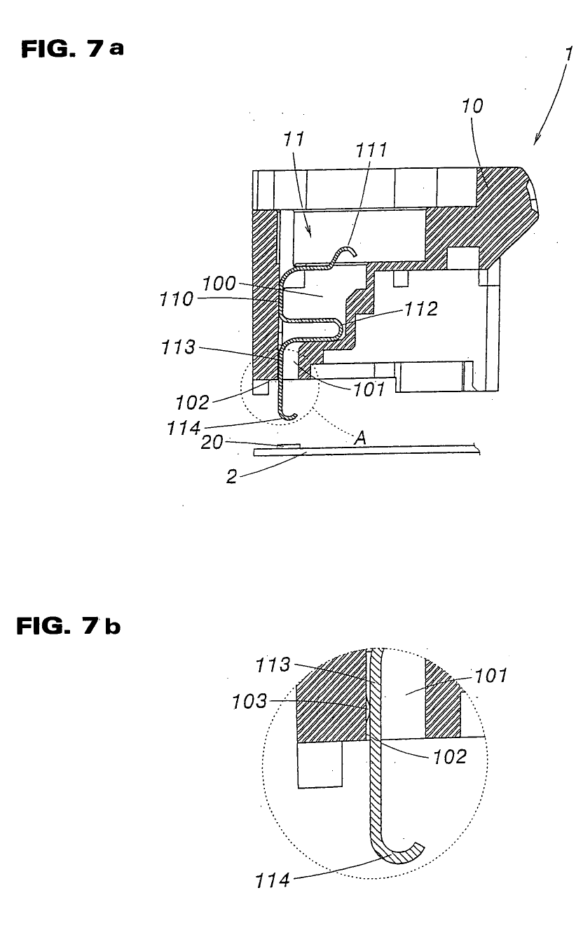

The housing 10 is injection-molded from plastics, comprising a plurality of terminal slots 100. Each terminal slot 100 has a bottom end terminating in a narrow passage 101 cut through the bottom side of the housing 10. The narrow passage 101 has one bearing sidewall 102 (see FIG. 7A). The other part of each terminal slot 100 is similar to the conventional designs.

The terminals 11 are respectively mounted in the terminal slots 100 of the housing 10, each having a positioning portion 110 positioned in the corresponding terminal slot 100, a top contact arm 111 extended from one side, namely, the top side of the positioning portion 110 and adapted to contact one contact of an external electronic device (not shown), a substantially U-shaped springy supporting portion 112 extended from the other side, namely, the bottom side of the positioning portion 110 and supported inside the corresponding terminal slot 100, a vertical arm 113 downwardly extended from one end of the U-shaped springy supporting portion 112 remote from the positioning portion 110 and stopped at the bearing sidewall 102 of the corresponding terminal slot 100, and a bottom contact tip 114 extended from one end of the vertical arm 113 remote from the U-shaped springy supporting portion 112 and suspended outside the housing 10 for the contact of the corresponding contact 20 of the circuit board 2. When the contacts 20 of the circuit board 2 set into contact with the contact tips 114 of the terminals 11, the vertical arm 113 of each terminal 11 is maintained perpendicular to the circuit board 2.

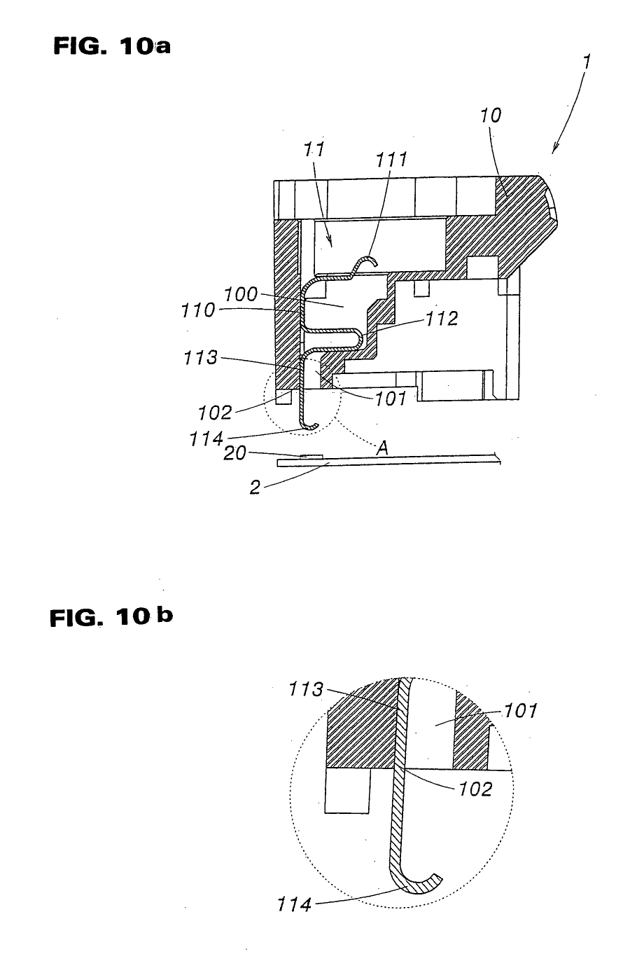

The housing 10 can be made having a protruded stop portion 103 in narrow passage 101 of each terminal slot 100 to support the vertical arm 113 of the corresponding terminal 11 (see FIG. 7A). Alternatively, the bearing sidewall 102 of each terminal slot 100 can be slightly sloping in one direction to support the vertical arm 113 in a slightly tilted position (see FIGS. 10 and 10A).

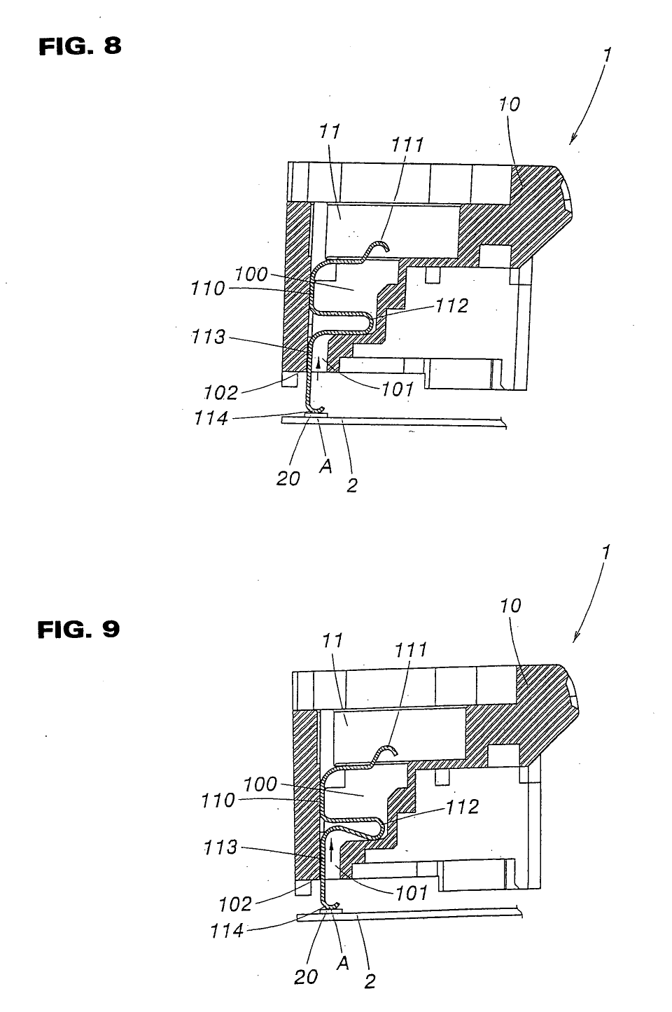

Referring to FIGS. 8 and 9, when the contact tip 114 of each terminal 11 touched the corresponding contact 20 of the circuit board 2, the pressure imparted from the circuit board 2 to each terminal 11 passes in direction parallel to the vertical arm 113, therefore the contact area between the contact tip 114 of each terminal 11 and the corresponding contact 20 of the circuit board 2 is constantly maintained in position A, i.e., the contact between the contact tip 114 of each terminal 11 and the corresponding contact 20 of the circuit board 2 is a point contact without producing a sliding friction. Because the contact between the contact tip 114 of each terminal 11 and the corresponding contact 20 of the circuit board 2 is a point contact, the circuit board 20 requires less installation space and, can be maintained in contact with the terminals 11 of the electric connector positively and stably Referring to FIGS. 7 and 7A, or 10 and 10A, the design of the protruded stop portion 103 in narrow passage 101 of each terminal slot 100 or the sloping design of the bearing sidewall 102 of each terminal slot 100 prevents the vertical arm 113 of the respective terminal 11 from biasing during installation of the circuit board 2.

A prototype of electric connector has been constructed with the features of the annexed drawings of FIGS. 5˜10. The electric connector functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. An electric connector comprising an electrically insulative housing, said housing comprising a plurality of terminal slots, and a plurality of terminals respectively mounted in said terminal slots of said housing and disposed in contact with respective contacts of a circuit board in an electronic apparatus, wherein
said terminals each comprise a springy supporting portion supported inside one terminal slot of said housing, a vertical arm downwardly extended from one end of said springy supporting portion, and a contact tip extended from a bottom end of said vertical arm remote from said springy supporting portion and suspended outside said housing for the contact of one contact of said circuit board.

2. The electric connector as claimed in claim 1, wherein said terminal slots of said housing each have a bottom end terminating in a narrow passage cut through a bottom side of said housing, said narrow passage having one bearing sidewall adapted to support the vertical arm of the corresponding terminal.

3. The electric connector as claimed in claim 2, wherein said bearing sidewall has a protruded stop portion stopped against one side of the vertical arm of the corresponding terminal.

4. The electric connector as claimed in claim 2, wherein said bearing sidewall slopes in one direction.

5. The electric connector as claimed in claim 1, wherein said terminals each further comprise a positioning portion integral with one end of said springy supporting portion remote from said vertical arm and positioned in the corresponding terminal slot inside said housing.

6. The electric connector as claimed in claim 5, wherein said terminals each further comprise a curved contact arm upwardly extended from one side of said positioning portion remote from said springy supporting portion.

7. The electric connector as claimed in claim 1, wherein the springy supporting portion of each of said terminals has a U-shaped profile.
